(19) United States
(12) Patent Application Publication
(10) Pub. No.: US 2009/0076783 A1
(43) Pub. Date: Mar. 19, 2009

(54) Digitally optimized fastener assembly and method of making the same

(75) Inventors: Kimberly H. Babusik, Mullica Hill, NJ (US); Cynthia A. Goliber, Phoenixville, PA (US)

Correspondence Address: Michael G. Panian;Covidien, 601 Allendale Road, King of Prussia, PA, 19406, US

(73) Assignee: Tyco Healthcare Retail Services AG, Neuhausen am Rheinfall (CH)

(21) Appl. No.: 11/900,850

(22) Filed: Sep. 13, 2007

(51) Int. Cl. G06G 7/48

(52) U.S. Cl. 703/6

(57) ABSTRACT

A method of making a digitally optimized fastener assembly for a disposable absorbent article can have the following steps: creating a first FEA model having first structural design properties and/or first material design properties; analyzing the first FEA model to obtain first failure characteristics; modifying the first structural design properties and/or the first material design properties to create a second FEA model having second structural design properties and/or second material design properties; analyzing the second FEA model to obtain second failure characteristics thereof; comparing the first failure characteristics to the second failure characteristics to determine whether there is an improvement over the first failure characteristics; and wherein the third through fifth steps can be repeated until a FEA model is created which exhibits desirable failure characteristics. A digitally optimized fastener assembly generally be a fastener assembly made according to the aforesaid method.

### BACKGROUND

The digitally optimized fastener assembly and method of making the same relate generally to fastener assemblies for disposable absorbent articles, and more particularly to a digitally optimized fastener assembly and method of making the same utilizing finite element analysis (FEA) methods.

Fastener assemblies for disposable absorbent articles or garments such as, for example, disposable diapers, training pants, adult incontinent pads, sanitary napkins, pantiliners, incontinent garments, and the like, which are generally worn in cooperation with garments and disposed against a body surface by infants or adult incontinent individuals. The absorbent article is employed to collect and absorb body fluid discharge, such as, for example, blood, menses, urine, aqueous body fluids, mucus and cellular debris. For example, the absorbent article may be disposed between the legs of an individual adjacent a crotch area, and positioned in engagement with a body surface of the crotch area to collect fluid discharge.

As is known in the art, absorbent articles typically include a fluid permeable cover stock for engaging the body surface, a fluid impermeable backsheet and an absorbent core supported therebetween. The backsheet serves as a moisture barrier to prevent fluid leakage to the garment. The absorbent core usually includes a liquid retention material that faces the body surface. The absorbent core can include, for example, loosely formed cellulosic fibers, such as, for example, wood pulp, fluff pulp, etc., for acquiring and storing body discharge. Elasticized regions can be provided around the edges of the article to secure the article about the waist and legs of a wearer.

Additionally, fastening of the absorbent articles on an individual requires the use of fasteners and/or ear members and closure tabs that extend laterally from the body of the absorbent article. Moreover, the closure tabs can conventionally have mechanical closure material, for example, hook and loop material, adhesive tape, and the like. For example, in typical diaper-type garments, the garment can be affixed to a wearer by attaching one or more closure tabs that extend across the wearer's hips to hold front and rear portions of the garment to one another.

FEA methods are also well known. Generally, FEA uses a complex system of points called nodes which make a grid called a “mesh.” This mesh is programmed to contain the material and structural properties which define how the structure will react to certain loading conditions. Nodes are assigned at a certain density throughout the material depending on the anticipated stress levels of a particular area. Regions which will receive large amounts of stress usually have a higher node density than those which experience little or no stress. Points of interest may consist of: fracture point of previously tested material, fillets, corners, complex detail, and high stress areas. The mesh acts like a spider web in that from each node, there extends a mesh element to each of the adjacent nodes. This web of vectors is what carries the material properties to the object, creating many elements. After the FEA model is prepared, the model is “run” to produce failure characteristics which are analyzed to ascertain whether there are potential defects in the design and/or whether any changes in the design can or should be made to improve the failure characteristics. “Running” the model means initiating the FEA program to evaluate the stresses and strains on the FEA model.

Conventional manners to develop and improve cost-effective materials and designs for fastener assemblies that display superior failure characteristics involve a great deal of time, effort and expense. Much of this time and expense can typically be associated with making and testing multiple prototype fastener assemblies which incorporate various design and material characteristics in order to determine the particular designs and materials, and combinations thereof, which exhibit desired failure characteristics. This process can often be an iterative process in which many different prototypes are made and tested in succession, each incorporating different designs and/or types of materials, in an effort to identify the particular combination which provides the most superior failure characteristics. As can be appreciated, this process can be both expensive and time consuming.

Therefore, it would be desirable to provide a digitally optimized fastener assembly and method of making the same utilizing FEA methods which enable a relatively large number of possible design and/or material combinations of fastener assemblies to be tested and evaluated in a comparatively short period of time. Such method can at the same time eliminate the added time and expense of having to create and test a prototype of each possible design and/or material combination.

### SUMMARY

A digitally optimized fastener assembly and method of making the same are described hereinafter. A method of making a digitally optimized fastener assembly for a disposable absorbent article can generally comprise (a) creating a first FEA model of a first fastener assembly, the first fastener assembly having first design properties; (b) running the first FEA model to obtain first failure characteristics; (c) evaluating the failure characteristics; and (d) at least one of: (i) making a fastener assembly corresponding to the first fastener assembly; and (ii) repeating the previous steps for at least a second FEA model for a second fastener assembly having second design properties, wherein the first design properties are modified to create the second design properties.

An embodiment of a digitally optimized fastener assembly can generally comprise a fastener assembly made according to one or more of the steps set forth in the method of making a digitally optimized fastener assembly described above.

One of ordinary skill in the art will understand that fastener assembly designs can likely be obtained which have failure characteristics that are superior in some respects, yet inferior in other respects, to designs of preceding models. Therefore, it is to be understood that the determination of whether a design has sufficiently desirable failure characteristics such as to be selected as the basis to manufacture an actual fastener assembly according to such design can result from the failure characteristics of such design having superior failure characteristics which are considered superior only in certain respects, and not necessarily superior in all possible respects.

Certain illustrative aspects of the digitally optimized fastener assembly and method of making the same are described herein in connection with the following description and the appended drawings. These aspects may be indicative of but a few of the various ways in which the principles of the digitally optimized fastener assembly and method of making the same may be employed, and which is intended to include all such aspects and any equivalents thereof. Other advantages and features of digitally optimized fastener assembly and method of making the same may become apparent from the following detailed description, when considered in conjunction with the appended drawing figures.

### BRIEF DESCRIPTION OF THE DRAWING FIGURES

A more complete understanding of the digitally optimized fastener assembly and method of making the same can be obtained by considering the following description in conjunction with the accompanying drawings, in which:

FIG. 1 illustrates an example of an FEA model for a digitally optimized fastener assembly.

FIG. 2 is a flow chart of an embodiment of a method of making a digitally optimized fastener assembly.

FIG. 3 illustrates an embodiment of an FEA model for a 3-piece fastener design.

FIG. 4 illustrates an embodiment of an FEA model for a 2-piece fastener design.

FIG. 5 is a graphical representation showing the results of a FEA of the model shown in FIG. 3.

FIG. 6 is a graphical representation showing the results of a FEA of the model shown in FIG. 4.

FIG. 7 is a graphical representation showing the results of a FEA of the model shown in FIG. 4 except having a different type of stretch material.

### DESCRIPTION OF CERTAIN EMBODIMENTS

The digitally optimized fastener assembly and method of making the same for disposable absorbent articles are discussed in terms of fluid absorbent articles, and more particularly, in terms of an absorbent article including fasteners that cooperate to improve attachment and fit. As used herein, the term “absorbent article,” “absorbent garment” or “garment” refers to absorbent articles that absorb and contain body liquids, discharge and waste, and more specifically, refers to absorbent articles that are placed against or in proximity to the body of the wearer to absorb and contain the various body liquids, discharge and waste. A non-exhaustive list of examples of absorbent articles includes diapers, diaper covers, disposable diapers, training pants, feminine hygiene products and adult incontinence products. The term absorbent article includes all variations thereof, including disposable absorbent articles that are intended to be discarded or partially discarded after a single use and unitary disposable absorbent articles that have essentially a single structure. As used herein, the term “diaper” refers to an absorbent article generally worn by children and incontinent persons about the lower torso. The claims are intended to cover all of the foregoing classes of absorbent articles, without limitation, whether disposable, unitary or otherwise. The invention will be understood to encompass, without limitation, all classes of absorbent articles, including those described above.

Absorbent articles and diapers may have a number of different constructions. In each of these constructions it is generally the case that an absorbent core is disposed between a liquid pervious, body-facing topsheet and a liquid impervious, exterior facing backsheet. In some cases, one or both of the topsheet and backsheet may be shaped to form a pant-like garment. In other cases, the topsheet, backsheet and absorbent core may be formed as a discrete assembly that is placed on a main chassis layer and the chassis layer is shaped to form a pant-like garment. The garment may be provided to the consumer in the fully assembled pant-like shape or may be partially pant-like and require the consumer to take the final steps necessary to form the final pant-like shape, such as by fastening one or more fasteners or fasteners.

In the case of some diapers and most adult incontinent products, the garment often is provided fully formed with factory-made side seams and the garment is donned by pulling it up the wearer's legs. In the case of most diapers, wherein, for example, a child lies on his or her back, a caregiver usually places the diaper between the child's legs, pulls the front end of the diaper up between the legs and then attaches one or more closure tabs to the front waist region of the diaper, thereby forming a pant-like structure. For clarity, the present invention is described herein only with reference to a diaper-type garment in which the topsheet, backsheet and absorbent core are assembled into a structure that forms a pant-like garment when secured on a wearer using fastening devices, although the invention may be used with any other type of absorbent garment that may benefit from the use or addition of fasteners.

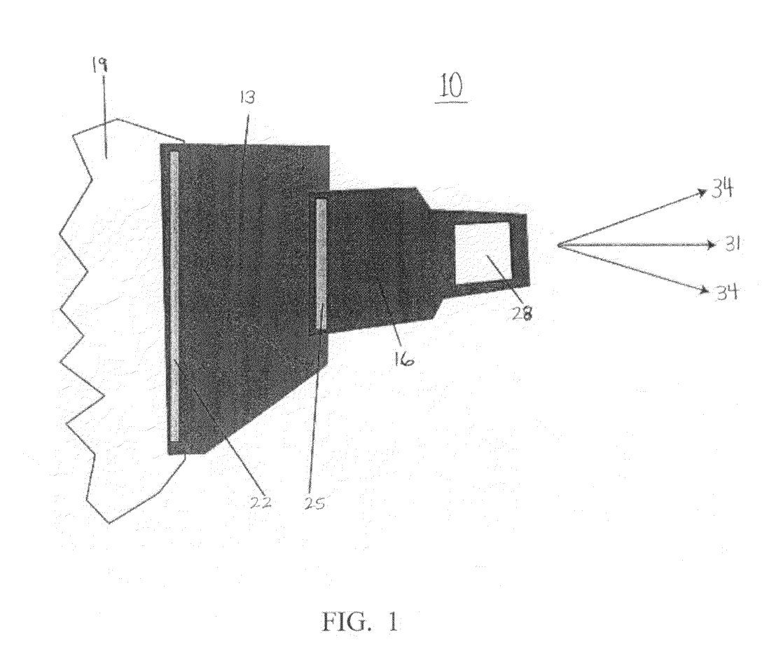

Referring now to the drawing figures wherein like reference numerals are used to refer to like elements throughout, an example of an FEA model 10 which can be utilized according to an embodiment of a method of making a digitally optimized fastener assembly is illustrated in FIG. 1. Basically, the FEA model 10 can be utilized to simulate, or anticipate, the behavior of elastic fastener assemblies, or “stretch tab,” as a force is distributed on the materials when a person pulls on the tab. The proper functioning of the stretch tab is a combination of the raw materials, dimensions of the tab, and the attachment system employed. As shown, the FEA model 10 can basically comprise a non-woven tab portion 13 attached to a distal tab portion 16. The non-woven tab portion 13 can be attached to a base absorbent system portion, also referred to below as the “diaper edge.” An attachment portion, for example, a hook and loop fastener system, can be provided on the distal tab portion 16. The non-woven tab portion 16 can be attached to the diaper edge and/or the stretch tab in a conventional manner, such as, for example, by ultrasonic welding. However, other attachment methods could alternatively be utilized/characterized for purposes of the FEA method. Further details of the FEA model 10 are provided hereinafter.

An overview of the modeling process can generally be: quantifying the geometry for the fasteners; collecting material properties; constructing the geometric model for FEA; applying material properties to the FEA model; and “running” the FEA model. The FEA model 10 can be created using, for example, a known stretch tab configuration, and then existing tab failure data can be used to validate the FEA model 10. Changes to the dimensions and shape of the fastener assembly can then be made, as can changes to the attachment system, and/or changes to the material types. For example, new stretch materials can then be characterized, and the FEA model 10 can be used to substitute in the new materials and predict the behavior of the stretch tab with the new materials in specific tab configurations. Similarly, changes to the dimensions, configuration and/or attachment system can be made and tested to predict the behavior of a fastener assembly incorporating any such changes. In this way, the most cost efficient and/or best performing stretch tab configuration and/or materials can be determined for a specific stretch tab configuration. Moreover, new fastener assembly designs can also be screened for possible defects before actually making the articles. Accordingly, the end result is a fastener attachment assembly design which is digitally optimized in for strength, shape, and overall performance, before manufacture and without having to make and test any prototypes.

FEA Model Development

The FEA modeling and analysis can be performed by any qualified vendor. The model development described herein can have three basic components: (1) quantify tab geometry; (2) develop material stress-strain properties for the various components; and (3) analyze the tabs under specified loading conditions. The geometry can be acquired by inspection of a physical diaper or through drawings. In either case, both the overall geometric dimensions and a description of the various material components is generated for the particular configuration to be modeled. By way of example only, the particular FEA model 10 described herein was developed using two dimensional membrane elements and solved in NASTRAN. The loading conditions were developed to be consistent with a testing protocol that could be duplicated and used for comparison between the experimental results and the theoretical predictions. Two loading cases were considered: a straight pull (arrow 31), with the load applied perpendicular to the seam between the diaper and the top/bottom nonwoven material; and an angled pull (arrows 34), with the load applied at a 45 degree angle to the first pull. In both loading cases, the “diaper edge” (i.e., the part of the fastener assembly that is attached to the diaper, or base absorbent system 19) was held with a three inch wide grip that prohibits any displacement of material. This is comparable to a fixed grip in a tensile testing frame. Also, in both cases the hook attachment region 28 was considered to be held in a grip and load was applied to this material. To perform the finite element analysis it was necessary to have stress-strain descriptions of the various component materials. This was obtained using actual samples from the provided materials which were subjected to mechanical testing. Most of the material involved is a continuous fabric with two different mechanical properties, so tests were performed on each of the components independently. The stress strain curves for the constituent materials where then developed and applied to the FEA model 10. To validate the FEA model 10, the stretch tabs were tested physically and the results compared with the FEA predictions.

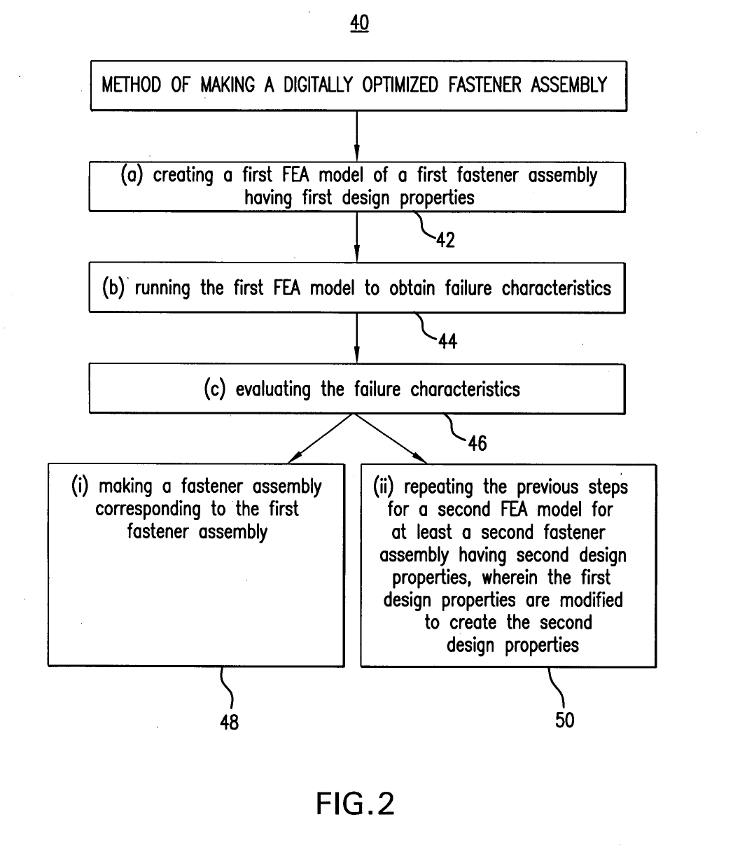

Referring now to FIG. 2, a flow chart 40 is shown which illustrates an embodiment of a method of making a digitally optimized fastener assembly utilizing FEA methods, wherein the method can generally comprise the following steps: 42 (a) creating a first FEA model of a first fastener assembly, the first fastener assembly having first design properties; 44 (b) running the first PEA model to obtain first failure characteristics; 46 evaluating the failure characteristics; and at least one of 48 (i) making a fastener assembly corresponding to the first FEA model; and 50 (ii) repeating the previous steps for at least a second FEA model for a second fastener assembly having second design properties, wherein the first design properties are modified to create the second design properties. In step 50, subsequent FEA models can be easily created and run for different fastener designs until a design is arrived at which the FEA model thereof indicates should exhibit desirable failure characteristics. At this point, a fastener assembly can be made corresponding to such FEA model. If desired, a prototype of such fastener design could be made and tested to verify that the actual failure characteristics conform to those predicted by the FEA model. Even in the case were a prototype is made and tested to confirm the FEA results, the there can still be a significant savings in time and expense by using the FEA method to test a virtually unlimited number of potential fastener assembly without having to make and test a prototype for each iteration.

The design properties can generally comprise dimensions, attachment configurations, and material properties of the fastener assembly. The attachment configurations can be, e.g., as in the example case described hereinafter, whether the fastener assembly is a 2-piece or 3-piece assembly. Each of various different design properties can be modified, altered and/or substituted to create different FEA models of fastener assemblies. The failure characteristics exhibited by different FEA models of fastener assemblies can be run and evaluated relative quickly, with the goal being to obtain an overall fastener design which exhibits superior failure characteristics, and without having to make and test a prototype each time any change in structural design or material properties are made. This process can also be used to screen proposed new designs for potential defects before making any actual articles having such proposed new fastener assemblies.

An embodiment of a digitally optimized fastener assembly can generally comprise a fastener assembly made according to the above described method.

One of ordinary skill in the art will understand that fastener assembly designs can likely be obtained which have failure characteristics that are superior in some respects, yet inferior in other respects, to designs of preceding models. Therefore, it is to be understood that the determination of whether a design has sufficiently desirable failure characteristics such as to be selected as the basis to manufacture an actual fastener assembly be based upon failure characteristics which may be considered superior only in certain respects. The failure characteristics thus need not be superior in all possible respects to be considered “desirable.”

### EXAMPLE

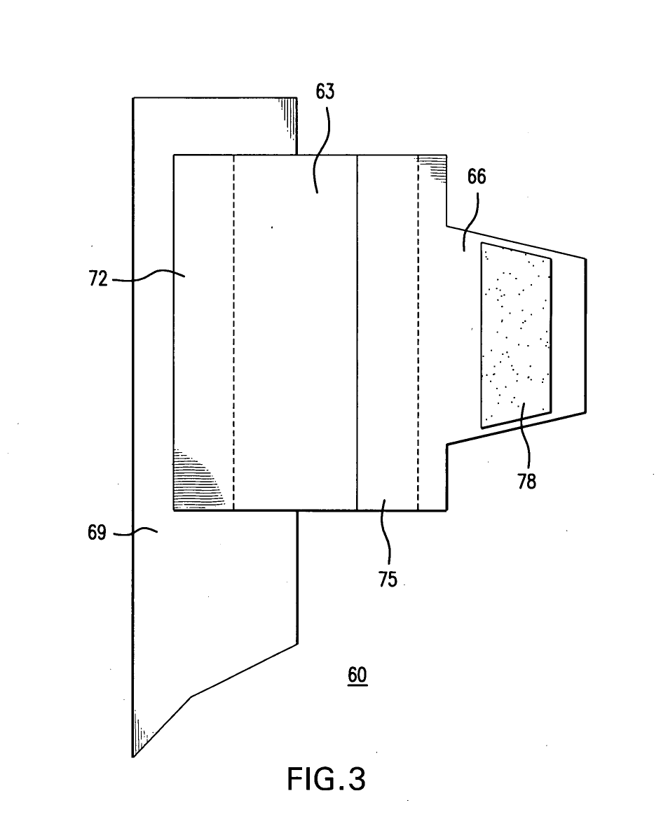

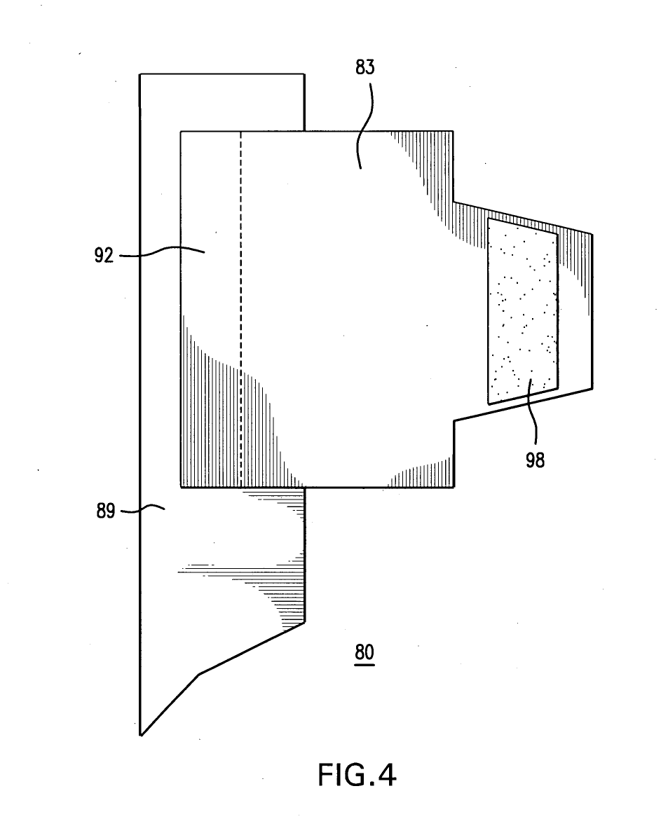

Three particular configurations were studied, according to one or more embodiment of the method described above. Two objectives of this particular study, for example, were to determine (1) what type of fastener assembly design would exhibit preferred failure characteristics, and (2) whether different types of materials would exhibit preferred failure characteristics when the fastener assembly design is identical. The three particular configurations studied in this example are as follow:
1. a 3-piece fastener assembly design 60 using a first type of stretch material, referred to as Type A (FEA model shown in FIG. 3);
2. a 2-piece fastener assembly design 80 using the same Type A stretch material (FEA model shown in FIG. 4); and
3. a 2-piece fastener assembly using a different stretch material, referred to as Type B (same FEA model 60 shown in FIG. 4).

FIGS. 3 through 7 illustrate examples of the method of making a digitally optimized fastener assembly described above, as set forth hereinafter in more detail. In particular, FIG. 3 illustrates an embodiment of a FEA model 60 of a 3-piece fastener assembly comprising a non-woven tab portion 63 attached to a distal tab portion 66. The non-woven tab portion 63 can be comprised of a non-woven/stretch film/non-woven laminate material. In the present example, the non-woven portion 63 can be made from Tredegar 308™, which is commercially available from Tredegar Film Products, 110 Boulders Parkway, Richmond, Va. 23225. The non-woven tab portion 63 can be attached to a base absorbent system 69 (diaper edge) and the distal tab portion 66 can have a hook/loop fastener portion 78. The distal tab portion 66 can comprised of a non-woven/non-stretch film/non-woven laminate material. Ultrasonic welds can be used to attach the non-woven tab portion 63 to the diaper edge 69 and the distal tab portion 66.

FIG. 4 illustrates an FEA model 80, wherein the FEA model 80 is basically the same as FEA model 60 shown in FIG. 3 except modified to represent a 2-piece fastener assembly. The FEA model 80 can generally comprise a non-woven tab portion 83 attached to a base absorbent system (diaper edge) 89. In this design, there is no corresponding distal tab portion attached to the non-woven tab portion 83. Instead, the distal tab portion and the non-woven tab portion 86 can be a single component, and a hook/loop fastener portion 98 can be attached to a distal end of the non-woven tab portion 86. The non-woven tab portion 83 can be comprised of a non-woven/stretch film/non-woven laminate material. In the present example, the non-woven portion 83 can be made from the Tredegar 308™, material described above. An ultrasonic weld or glue adhesive, for example, can be used to attach the non-woven tab portion 83 to the diaper edge 89.

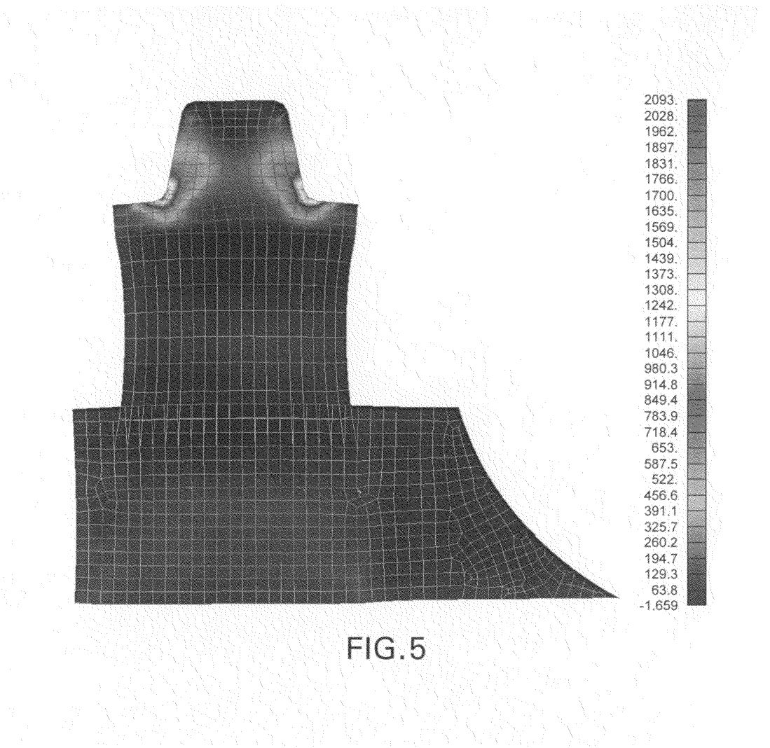

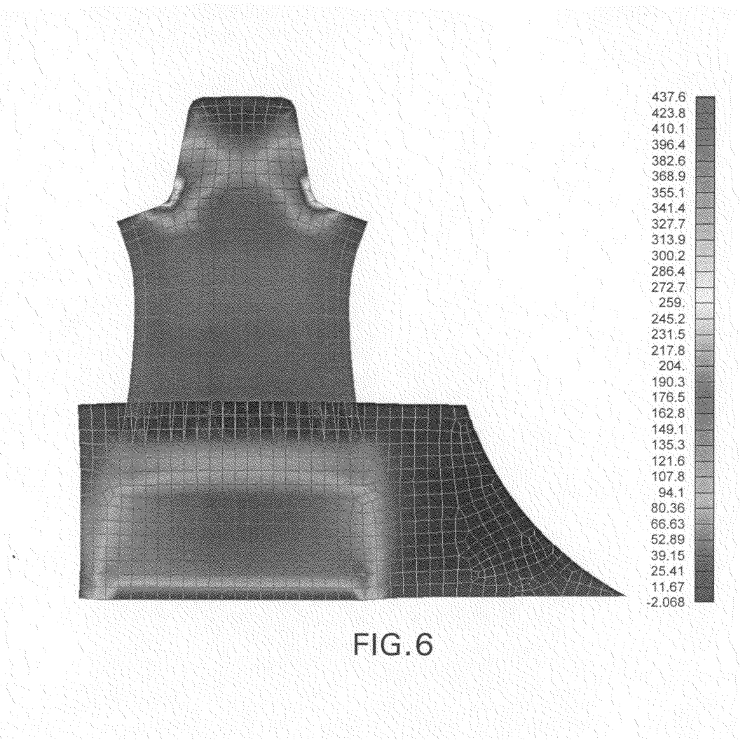

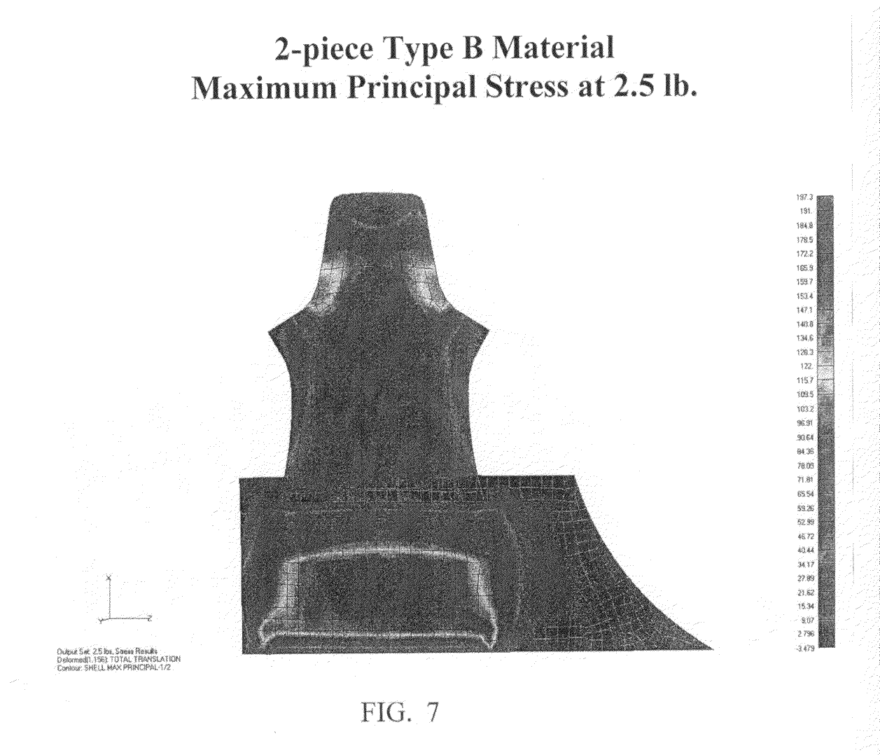

FIGS. 5 through 7 are graphical illustrations of failure characteristics obtained from “running” the FEA models for three the examples listed above. The failure characteristics shown in FIGS. 5 and 6 correspond to the FEA modes 60 and 80, respectively, and the failure characteristics illustrated in FIG. 7 correspond to a third FEA model (not shown, but is the third example described in the list above). The third FEA model is identical to the FEA model in FIG. 4, except that a different material, having different material properties, is substituted for one of the components. Specifically, the non-woven tab portion 83 in FIG. 4 can be comprised of an alternative material instead of the Tredegar 308™ described previously. In particular, the non-woven tab portion can be comprised of a non-woven/stretch film/non-woven laminate material referred to as Tredegar Fabriflex 506™. In all other respects, the FEA model used to obtain the third failure characteristics can be identical to the FEA model 80 shown in FIG. 4.

The results of the study are illustrated in the following table:

| | | | Applied | Peak | Peak | |
|---|---|---|---|---|---|---|
| | | Load | Load | Stress | Strain | Peak Deflection |
| Model | Material | Case | lbs | psi | in/in | inches |
| 3 Pc | Type A | 1 | 5 | 3,297 | 0.506 | 0.663 |
| | | | 2.5 | 2,093 | 0.242 | 0.318 |
| | | 2 | 5 | 4,274 | 0.86 | 0.998 |
| | | | 2.5 | 3,115 | 0.411 | 0.48 |
| 2 Pc | Type A | 1 | 5 | 774 | 0.525 | 0.719 |
| | | | 2.5 | 438 | 0.251 | 0.346 |
| | | 2 | 5 | 1,139 | 0.934 | 1.11 |
| | | | 2.5 | 664 | 0.445 | 0.537 |
| 2 Pc | Type B | 1 | 5 | 406 | 2.75 | 3.56 |
| | | | 2.5 | 197 | 0.839 | 1.156 |
| | | 2 | 5 | 917 | 5.717 | 6.589 |
| | | | 2.5 | 478.2 | 1.27 | 1.863 |

As shown in the table, two different load cases were used, one at 5 lb. load and one at 2.5 lb. load, as were two different material types, Type A and Type B. The results of the tests show that the 3-piece model has less stretch and more stress than either of the 2-piece designs. Additionally, the 2-piece reduces the stress at equal stretch, and also that the 2-piece design with the Type B stretches three times more than the Type B material, and with less than one half of the stress of the Type A material. In this particular example, the Type A material can be Tredegar 308™ and the Type B material can be Tredegar Fabriflex 506™.

As a result of these tests, it was possible—without having to create and test a physical prototype- to determine that a 2-piece design had more desirable failure characteristics than the 3-piece design, and also that substituting a different material, in otherwise identical designs, provided improved failure characteristics. Thus, a digitally optimized fastener assembly could be identified for manufacture in a more efficient and less expensive manner than heretofore done according to conventional methods.

Therefore, what has been described above includes exemplary embodiments of a digitally optimized fastener assembly for disposable absorbent articles and method of making the same. It is, of course, not possible to describe every conceivable combination of components or methodologies for purposes of this description, but one of ordinary skill in the art may recognize that further combinations and permutations are possible in light of the overall teaching of this disclosure. Accordingly, the description provided herein is intended to be illustrative only, and should be considered to embrace any and all alterations, modifications, and/or variations that fall within the spirit and scope of the appended claims.

What is claimed is:

1. A method of making a digitally optimized fastener assembly for an absorbent article, said method comprising:
(a) creating a first FEA model of a first fastener assembly having first design properties;
(b) running said first FEA model to obtain failure characteristics of said first fastener assembly;
(c) evaluating said failure characteristics; and
(d) at least one of
(i) making a fastener assembly corresponding to said first fastener assembly; and
(ii) repeating steps (a) through (d) for at least a second FEA model for a second fastener assembly having second design properties, wherein said first design properties are modified to create said second design properties.

2. The method of claim 1 wherein said first design properties comprise at least one of dimensions, attachment configurations, and materials.

3. The method of claim 1 wherein said first fastener assembly comprises a proposed new design, and wherein evaluating said failure characteristics comprises screening said proposed new design for potential defects.

4. The method of claim 1 wherein said first design properties comprise a first type of material and said second design properties comprise a second type of material.

5. The method of claim 1 wherein said first design properties comprise a first attachment configuration and said second design properties comprise a second attachment configuration.

6. A digitally optimized fastener assembly made according to the method of claim 1.

7. A digitally optimized fastener assembly made according to the method of claim 3.
